(19) United States
(12) Patent Application Publication
(10) Pub. No.: US 2003/0220935 A1
(43) Pub. Date: Nov. 27, 2003

(54) Method of logical database snapshot for log-based replication

(76) Inventors: Stephen J. Vivian, Londonderry, NH (US); Raymond Guzman, Amherst, NH (US)

Correspondence Address: DITTHAVONG & CARLSON, P.C., 10507 Braddock Rd, Suite A, Fairfax, VA, 22032, US

(21) Appl. No.: 10/417,724

(22) Filed: Apr. 17, 2003

Related U.S. Application Data
(60) Provisional application No. 60/381,797, filed on May 21, 2002.

(51) Int. Cl. G06F 17/00

(52) U.S. Cl. 707/102

(57) ABSTRACT

A method of logical database snapshot for log-based replication in described that need not incur a quiescence of an operational database. Baselines for the overall snapshot operation and for each table replication are recorded in such a way that subsequent log-based replication can distinguish which redo records to apply and which to discard. The baselines may be recorded as system change numbers negotiated according to a distributed protocol for synchronizing a sequence number, and records from the redo log are applied on the logical standby system based on the recorded system change numbers.

### RELATED APPLICATIONS

The present application is related to U.S. Patent Application Serial No. 60/381,797 filed on May 21, 2002 (attorney docket number 50277-1057), the contents of which are hereby incorporated by reference.

### FIELD OF THE INVENTION

The present invention relates to database systems and more particularly to obtaining a snapshot of a database.

### BACKGROUND OF THE INVENTION

Organizations use computer databases to store, organize, and analyze some of their most important information. For example, a business may employ a database to warehouse its sales and ordering information so that analysts can predict trends in product sales or perform other kinds of data mining for long-range planning. Because database systems are responsible for managing information vital to the organization's operation, it is crucial for mission-critical database systems to implement mechanisms for recovery following a database system failure.

One approach to implementing disaster recovery is to deploy a “standby” database system that is a replica of the business's primary database system. The standby database is typically created from a backup of the primary database, and the primary database and the standby database coordinate with each other such that the standby database keeps up with changes made on the primary database. In the event of an irrecoverable crash or other disaster, the standby database can quickly be activated to become the business' new primary database without having to wait for restoring the primary database from the last backup and redo logs.

One approach involves generating a physical copy of the primary database (e.g, 501, 601) and then applying log records that arrive subsequent to the physical capture that are transmitted either synchronously or in batches. The use of physical copies of the database has the drawback of constraining the standby (or replicated) database (e.g., 503, 603) to having the identical physical properties of the primary database; this constraint imposes inflexibility for the database administrator with respect to optimizing resources. Accordingly, utilization of logical copies has gained significant attention.

A logical copy of the primary database could serve as the starting point for logical replication which would enable physical characteristics of the database to differ between the primary database and the standby database. One traditional approach for generating a logical snapshot is through use of an Import/Export tool. The Import/Export tool creates a logical copy of the database, but has the drawback of requiring a quiescence of the primary database. Quiescence is the process of halting some or all operations on a database system, usually for the purpose of gathering data or metadata. Consequently, the availability of the database system is reduced for the time that the database system is quiesced. Traditional database systems attempt to minimize disruption of database operation by performing a quiescence of the primary database during off-peak hours; however, it is becoming increasingly common that databases require around the clock operation (e.g., Internet commerce applications). As a result, quiescing the primary database is often unacceptable to many customers.

Another drawback of the Import/Export tool is that the interface is file-based, which requires operator intervention to move files once export is complete and then re-initiate operation to import the data on the standby database. A further drawback is that Export dump files may not be downward compatible and may not be capable of being imported if such files originated from a higher version of the database.

Therefore, there is a need for obtaining a logical snapshot of a database without interrupting or suspending operation of the database. There is also a need for a simplified database replication procedure that does not require operator intervention.

### SUMMARY OF THE INVENTION

These and other needs are addressed by the present invention by extracting a change number generated at the primary database system from a message, such as a distributed Structured Query Language (SQL) call, sent between the primary database system and the logical database system in accordance with a distributed protocol for synchronizing change numbers between systems and establishing that change number as a baseline change number. Quiescence of the primary database is avoided because the primary database can remain operational, but the determination of how to the update the logical standby database is based on established baseline change numbers. In one embodiment, there is an overall operational baseline change number for the operation of instantiating a snapshot of the operational database as well as baseline change numbers for the tables or other database objects.

In accordance with one aspect of the present invention, a method and software related to providing a logical standby database system for a primary database system. In this approach, a change number that was generated on a primary database system is extracted from a message transmitted between the primary database system and the logical standby database system according to a protocol that synchronizes the change number between the primary database and the logical standby database. The change number extracted from the message is established as a baseline change number for a target table on the logical standby database system that corresponds to a source table on the primary database system. A redo log record for the source table transmitted from the primary database system is selectively application to target table on the logical standby database system based upon the received baseline change number and a change number of the redo record.

Still other aspects, features, and advantages of the present invention are readily apparent from the following detailed description, simply by illustrating a number of particular embodiments and implementations, including the best mode contemplated for carrying out the present invention. The present invention is also capable of other and different embodiments, and its several details can be modified in various obvious respects, all without departing from the spirit and scope of the present invention. Accordingly, the drawing and description are to be regarded as illustrative in nature, and not as restrictive.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is a diagram of a database system capable of providing logical snapshots, according to one embodiment of the present invention;

FIG. 2 is a flowchart of a log-based replication process, according to one embodiment of the present invention;

FIGS. 3A and 3B are flowcharts of a process for generating a logical snapshot that can be used for log-based replication, according to one embodiment of the present invention; and

FIG. 4 is a diagram of a computer system that can be used to implement an embodiment of the present invention.

### DESCRIPTION OF THE PREFERRED EMBODIMENT

A system, method, and software for providing a logical snapshot of a database are described. In the following description, for the purposes of explanation, numerous specific details are set forth in order to provide a thorough understanding of the present invention. It is apparent, however, to one skilled in the art that the present invention may be practiced without these specific details or with an equivalent arrangement. In other instances, well-known structures and devices are shown in block diagram form in order to avoid unnecessarily obscuring the present invention.

In a database management system, data is stored in one or more data containers, each container contains records, and the data within each record is organized into one or more fields. In relational database systems, the data containers are referred to as tables, the records are referred to as rows, and the fields are referred to as columns. In object-oriented databases, the data containers are referred to as object classes, the records are referred to as objects, and the fields are referred to as attributes. Other database architectures may use other terminology.

Systems that implement the present invention are not limited to any particular type of data container or database architecture. However, for the purpose of explanation, the terminology and examples used herein shall be that typically associated with relational databases. Thus, the terms “table,” “row,” and “column” shall be used herein to refer respectively to the data container, record, and field.

### Architectural Overview

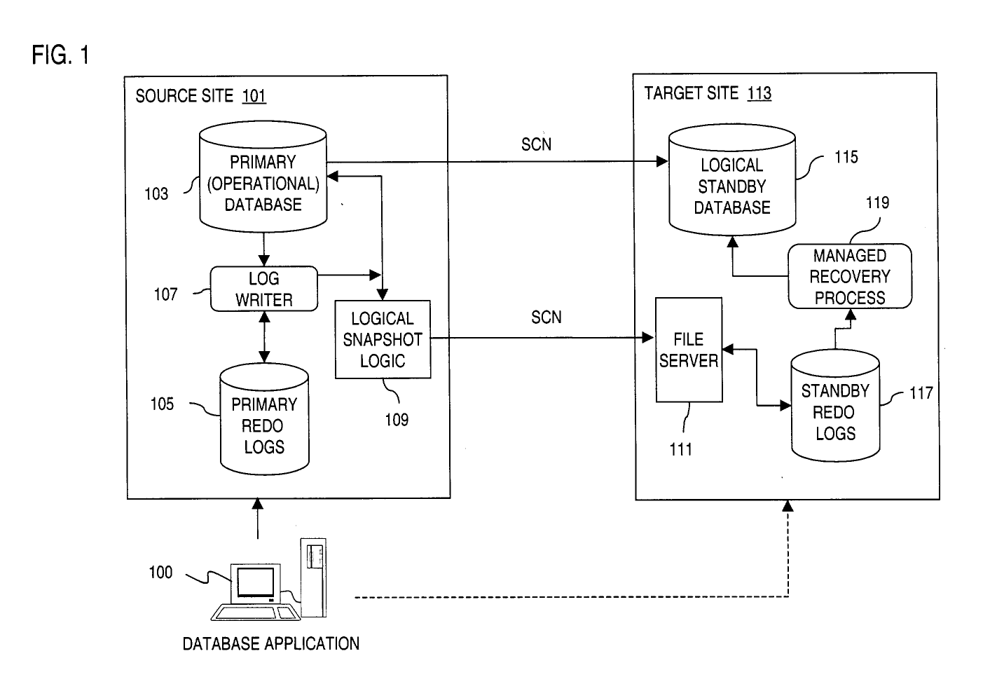

FIG. 1 is a diagram of a database system capable of providing logical snapshots, according to one embodiment of the present invention. A database application 100 has access to a source site 101, which, in an exemplary embodiment, can be an on-line transaction processing system for executing and keeping track of transactions for a business. For example, the database application 100 is responsible for interacting with employees or customers of the business. In response to commands and queries from the user of the database application 100, the database application 100 interacts with a database 103 for storing and retrieving data.

The source site 101 supports logical replication of databases by making use of a recovery log (i.e., redo log) 103 produced by an operational database 103. The redo log 103 is produced by the database system 105 in the normal course of operation to allow users to undo transactions (e.g., in a transaction rollback) and to provide for recovery after a system crash. Recovery logs 103 thus provide a way to cancel or to abort a transaction before the transaction is committed. The redo log records all changes made to the database 103. A logical snapshot of the operational database 101 can be taken with no operator intervention and without disrupting normal operations, simultaneously capturing the source state. That is, the database 103 is not quiesced, as in conventional systems; as previously mentioned, a quiesce of a database involves halting operations on the database system.

Replication baselines for the entire operation and for each table of the database 103 are established and made available, for example, to a log-based replication engine. The replication baseline represents the point at which the following two conditions are met for subsequent log-based replication operations: (1) no operations that occur subsequent to the baseline can be missed; and (2) no operations in the redo log stream that occurred prior to the baseline can be re-applied.

Logical snapshot logic 109 forwards source state information to a file server 111 within a target site 113, which houses a logical snapshot of the primary database 103 as a standby database 115. The standby database 115 maintains a logical copy of the primary (also known as production or operational) database 103 and provides continued primary database availability in the event of a disaster. The standby database 115 employs a redo log 117, as managed by a recovery process 119, to maintain consistency with the primary database 103, according to the received state information.

Each event in the primary database 103 and the logical standby database 115, e.g., update, insert, delete, and commit, is identified by a system change number that is a monotonically increasing number that identifies every operation performed on a database system that can be used to order the operations performed in the database system. The present invention is not limited to any particular implementation of system change numbers, and the concepts disclosed herein may be employed with timestamps, incrementing serial numbers, and the like. Every time a user commits a transaction, a new system change number is generated.

The system change numbers of the primary database 103 node and the logical standby database 115 node can be synchronized using a Lamport protocol, in which every message that is sent between nodes bears a system change number that indicates the current time of a local clock. When a node receives a “piggybacked” system change number from another node which is running fast, the node receiving the system change number would resynchronize its local clock forward to the faster time. This procedure ensures a partial ordering upon the distributed system. That is, causes have a lower system change number than their effects, because each transaction carries with it the most recent system change number it has seen so far. By the time the system change number is generated for the completed transaction, the system change number will have a greater value than any of the prior transactions in the chain of messages. Details of the Lamport technique are more fully described in the commonly-assigned U.S. Pat. No. 6,125,368 to Bridge et al., which is incorporated by reference in its entirety.

### Logical, Log-Based Replication

Under the arrangement of FIG. 1, the task of populating what will become the standby database 115 can be accomplished during operation of the primary database 103, in which precise baselines for log-based replication are established. The database system that will become the standby database 115 can initially be set up as a shell database system that includes various system schemas but does not yet contain the tables and other database objects that correspond to the tables and other database objects on the primary database 103. The tables to be part of the logical standby can be then created locally using metadata obtained from the operational database 103.

The source state of the primary database 103 when the snapshot of the data is taken is made known to the future standby database 115, according to an embodiment of the present invention, by an embedded system change number capture operation which takes advantage of the fact that system change numbers are negotiated between the databases for distributed commands. This embedded system change number capture advantageously permits a variety of tools to be used or written that make use of a distributed INSERT-SELECT command to extract source table data from the primary database 103 and write it to a target table on what is becoming target site 113, which will become the standby database 115.

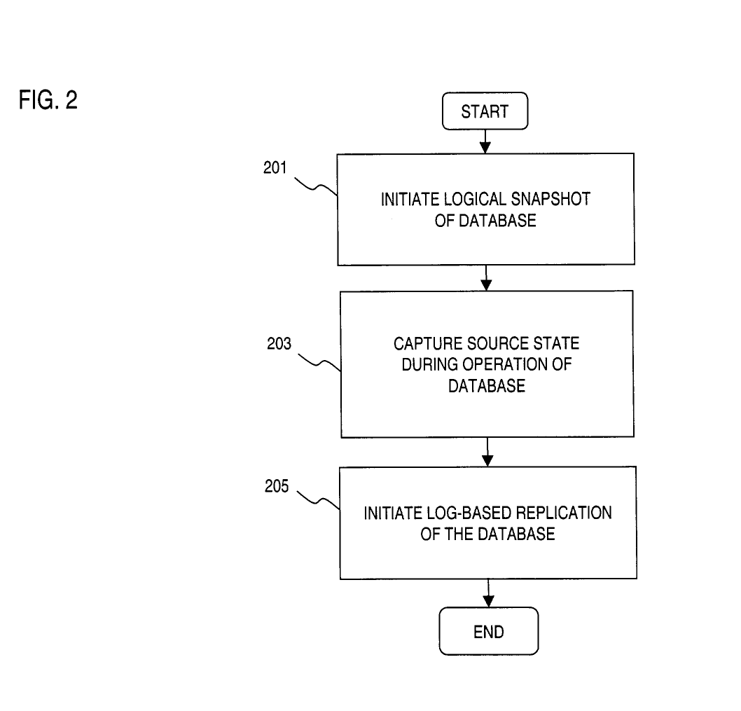

FIG. 2 is a flowchart of a logical standby instantiation and log-based replication process, according to one embodiment of the present invention. In step 201, a logical snapshot of the database 103 is initiated. The source state of the database 103 is then captured without the need to quiesce the database 103, as in step 203. In an exemplary embodiment, the source state is reflected in the system change number of the objects of the database 103. Thereafter, log-based replication of the database 103 can be initiated, per step 205. This process can be encapsulated within a stored procedure and executed as a single step operation. Unlike Import/Export approaches, this embodiment of the present invention does not require file transfer nor any operator intervention.

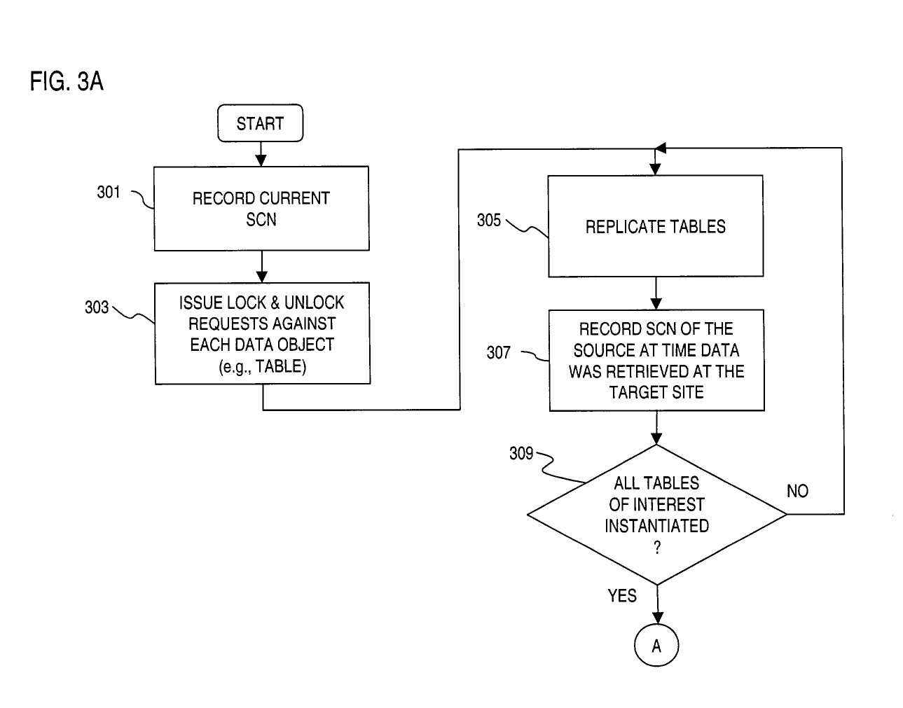

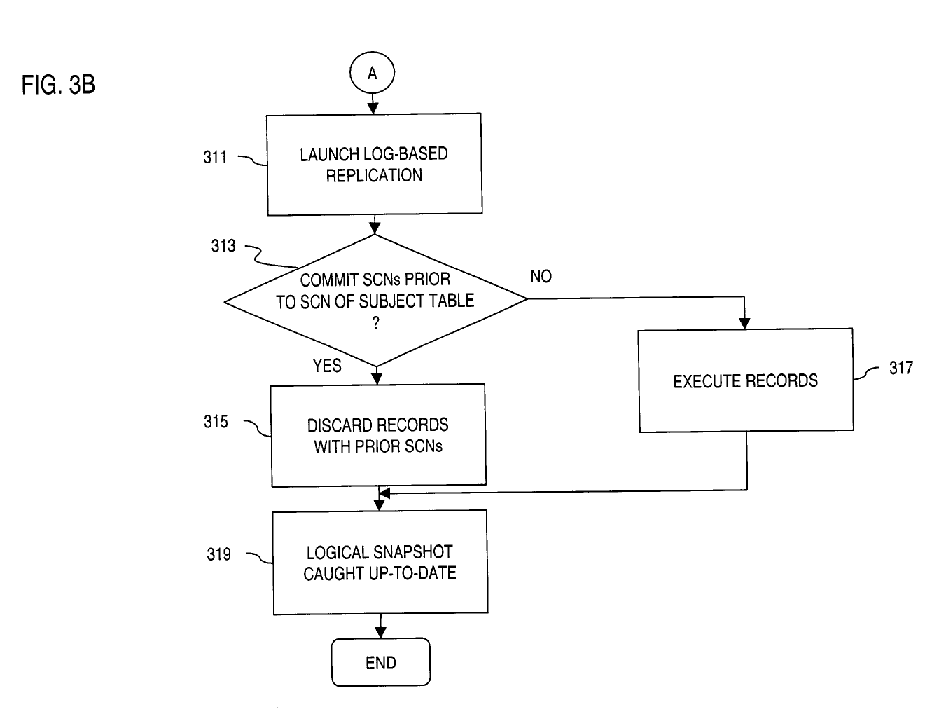

FIGS. 3A and 3B are flowcharts of a process for generating a logical snapshot that can be used for logical standby instantiation and log-based replication, respectively, according to one embodiment of the present invention. A baseline for the entire operation is established by recording the current system change number, as in step 301. Next, in step 303, to ensure that no earlier operations are undetected, lock requests are issued against each table and immediately unlocked. These lock and unlock requests may be distributed calls as well. Locking and then unlocking each table helps establish the recorded operational baseline system change number as the starting point for the replication engine and ensuring that no in-flight transactions exist that straddle the operational baseline system change number, thereby facilitating the determination of whether the records have already been applied to a table.

Throughout the entire instantiation operation, any number of new operations may occur on the operational database 103 as these operations are not blocked and the operational database 103 is advantageously not quiesced. As a result, gaps may exist between the operational starting point system change number and the actual replication of tables; however, obtaining a baseline change number for each replicated table in addition to the operational baseline change number helps to coordinate the application of changes to each table starting from each table's own baseline change number.

Specifically, the tables of the source database 103 can be cloned or replicated while capturing the system change number that was current when the data is extracted, per step 305. Each table can be replicated, for example, using any standard database tool that employs a distributed INSERT-SELECT command to load the data. In accordance with the Lamport protocol, this distributed command also includes, on the return path, the system change number on the target database 115, which is extracted for synchronization with the system change number on the source site 101. Due to this synchronization process, a valid, baseline system change number is known and captured for each replicated table. Accordingly, the tables are assigned different baseline system change numbers. Knowledge of the baseline system change number of each table is used to determine when the replication engine is to begin processing. Unlike the conventional approaches, this approach avoids interruption from normal operations to the primary database 103. If the database had been quiesced throughout the entire operation (as is the case with these conventional approaches), there would be no such differences in starting system change numbers.

In an exemplary embodiment, logic exists in the execution path of the INSERT-SELECT statement, whereby the system change number current on the source site 101 at the time the data was retrieved could be recorded at the target site 113 (per step 307) and subsequently used when the redo log records are evaluated for application during log-based replication. Even though the INSERT is issued from the target database 115, the system change number of the source database 103 can be known because distributed commands can negotiate the system change number using a distributed protocol, such as the Lamport protocol, for synchronizing sequence numbers between the sites 101, 113. Once all tables of interest have been instantiated (per step 309), the target database 115 can now be considered a logical standby database.

Referring now to FIG. 3B, the logical standby database 115 can be kept up-to-date by, for example, a standard log-based replication engine that can be started and make use of the recorded system change numbers in determining which records to apply from the redo log stream, as in step 311. Any records prior to the operational baseline system change number can be discarded as they would have already been captured in the instantiation process of FIG. 3A. Records with commit system change numbers prior to a particular table's recorded system change number are discarded, per steps 313 and 315, as that data already exists in the table, while those records with higher system change number are to be executed (per step 317) as they have occurred after the snapshot of data currently in the table. Thus, a logical snapshot of the database 103 is brought up-to-date (step 319).

As evident from the above process, the logic 109 supports populating a logical standby database 115, copying some subset of tables from an operational database. The concept of cloning a table while capturing the system change number current when the data is extracted can be advantageously applied to “fixing” a table that has become corrupted or otherwise diverged from the source table being replicated as well. A snapshot of a table can be taken at any point in time and that point in time can be recorded by way of the system change number. Also, the notion of system change number capture can be advantageously used on databases systems that have the notion of system change number and the ability to negotiate it in a distributed manner.

### Hardware Overview

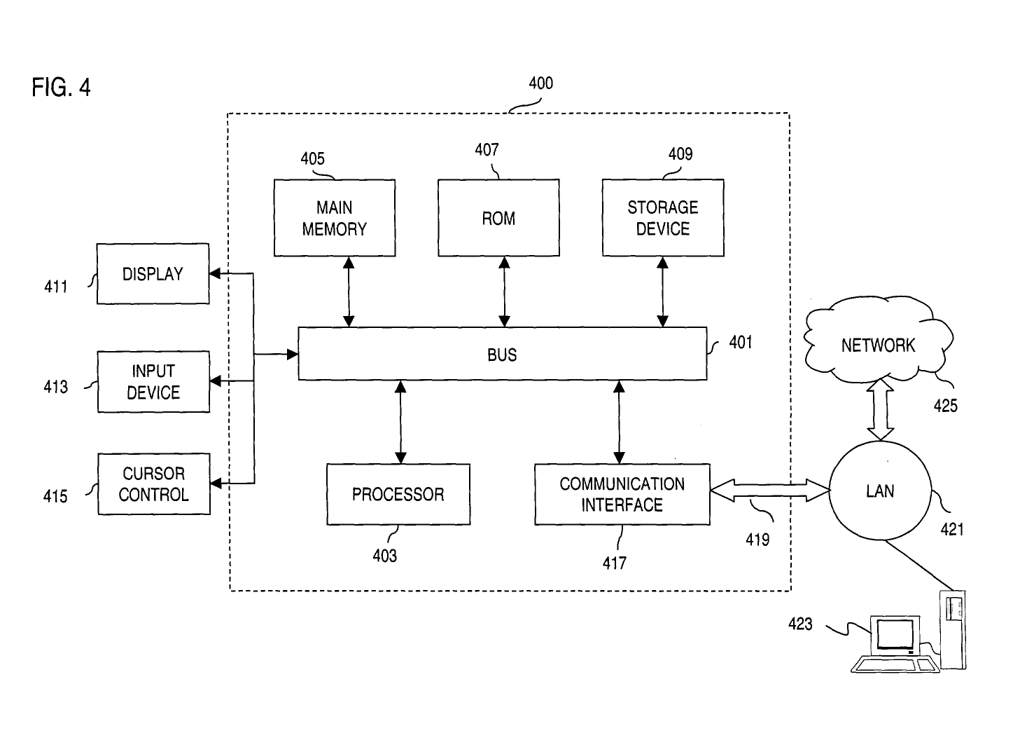

FIG. 4 illustrates a computer system 400 upon which an embodiment according to the present invention can be implemented. The computer system 400 includes a bus 401 or other communication mechanism for communicating information and a processor 403 coupled to the bus 401 for processing information. The computer system 400 also includes main memory 405, such as a random access memory (RAM) or other dynamic storage device, coupled to the bus 401 for storing information and instructions to be executed by the processor 403. Main memory 405 can also be used for storing temporary variables or other intermediate information during execution of instructions by the processor 403. The computer system 400 may further include a read only memory (ROM) 407 or other static storage device coupled to the bus 401 for storing static information and instructions for the processor 403. A storage device 409, such as a magnetic disk or optical disk, is coupled to the bus 401 for persistently storing information and instructions.

The computer system 400 may be coupled via the bus 401 to a display 411, such as a cathode ray tube (CRT), liquid crystal display, active matrix display, or plasma display, for displaying information to a computer user. An input device 413, such as a keyboard including alphanumeric and other keys, is coupled to the bus 401 for communicating information and command selections to the processor 403. Another type of user input device is a cursor control 415, such as a mouse, a trackball, or cursor direction keys, for communicating direction information and command selections to the processor 403 and for controlling cursor movement on the display 411.

According to one embodiment of the invention, the process of providing a logical snapshot is provided by the computer system 400 in response to the processor 403 executing an arrangement of instructions contained in main memory 405. Such instructions can be read into main memory 405 from another computer-readable medium, such as the storage device 409. Execution of the arrangement of instructions contained in main memory 405 causes the processor 403 to perform the process steps described herein. One or more processors in a multi-processing arrangement may also be employed to execute the instructions contained in main memory 405. In alternative embodiments, hard-wired circuitry may be used in place of or in combination with software instructions to implement the embodiment of the present invention. Thus, embodiments of the present invention are not limited to any specific combination of hardware circuitry and software.

The computer system 400 also includes a communication interface 417 coupled to bus 401. The communication interface 417 provides a two-way data communication coupling to a network link 419 connected to a local network 421. For example, the communication interface 417 may be a digital subscriber line (DSL) card or modem, an integrated services digital network (ISDN) card, a cable modem, a telephone modem, or any other communication interface to provide a data communication connection to a corresponding type of communication line. As another example, communication interface 417 may be a local area network (LAN) card (e.g. for Ethernet™ or an Asynchronous Transfer Model (ATM) network) to provide a data communication connection to a compatible LAN. Wireless links can also be implemented. In any such implementation, communication interface 417 sends and receives electrical, electromagnetic, or optical signals that carry digital data streams representing various types of information. Further, the communication interface 417 can include peripheral interface devices, such as a Universal Serial Bus (USB) interface, a PCMCIA (Personal Computer Memory Card International Association) interface, etc. Although a single communication interface 417 is depicted in FIG. 4, multiple communication interfaces can also be employed.

The network link 419 typically provides data communication through one or more networks to other data devices. For example, the network link 419 may provide a connection through local network 421 to a host computer 423, which has connectivity to a network 425 (e.g. a wide area network (WAN) or the global packet data communication network now commonly referred to as the “Internet”) or to data equipment operated by a service provider. The local network 421 and network 425 both use electrical, electromagnetic, or optical signals to convey information and instructions. The signals through the various networks and the signals on network link 419 and through communication interface 417, which communicate digital data with computer system 400, are exemplary forms of carrier waves bearing the information and instructions.

The computer system 400 can send messages and receive data, including program code, through the network(s), network link 419, and communication interface 417. In the Internet example, a server (not shown) might transmit requested code belonging to an application program for implementing an embodiment of the present invention through the network 425, local network 421 and communication interface 417. The processor 403 may execute the transmitted code while being received and/or store the code in storage device 49, or other non-volatile storage for later execution. In this manner, computer system 400 may obtain application code in the form of a carrier wave.

The term “computer-readable medium” as used herein refers to any medium that participates in providing instructions to the processor 405 for execution. Such a medium may take many forms, including but not limited to non-volatile media, volatile media, and transmission media. Non-volatile media include, for example, optical or magnetic disks, such as storage device 409. Volatile media include dynamic memory, such as main memory 405. Transmission media include coaxial cables, copper wire and fiber optics, including the wires that comprise bus 401. Transmission media can also take the form of acoustic, optical, or electromagnetic waves, such as those generated during radio frequency (RF) and infrared (IR) data communications. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, and EPROM, a FLASH-EPROM, any other memory chip or cartridge, a carrier wave, or any other medium from which a computer can read.

Various forms of computer-readable media may be involved in providing instructions to a processor for execution. For example, the instructions for carrying out at least part of the present invention may initially be borne on a magnetic disk of a remote computer. In such a scenario, the remote computer loads the instructions into main memory and sends the instructions over a telephone line using a modem. A modem of a local computer system receives the data on the telephone line and uses an infrared transmitter to convert the data to an infrared signal and transmit the infrared signal to a portable computing device, such as a personal digital assistant (PDA) or a laptop. An infrared detector on the portable computing device receives the information and instructions borne by the infrared signal and places the data on a bus. The bus conveys the data to main memory, from which a processor retrieves and executes the instructions. The instructions received by main memory can optionally be stored on storage device either before or after execution by processor.

While the present invention has been described in connection with a number of embodiments and implementations, the present invention is not so limited but covers various obvious modifications and equivalent arrangements, which fall within the purview of the appended claims.

What is claimed is:

1. A method for providing a logical standby database system for a primary database system, comprising:
extracting a change number generated on a primary database system from a message transmitted between the primary database system and the logical standby database system in accordance with a protocol that synchronizes the change number between the primary database and the logical standby database;
establishing the change number extracted from the message as a baseline change number for a target table on the logical standby database system that corresponds to a source table on the primary database system; and
selectively applying a redo record for the source table transmitted from the primary database system to target table on the logical standby database system based upon the baseline change number and a change number of the redo record.

2. A method according to claim 1, further comprising:
issuing a lock request against the source table followed by an unlock request against the source table.

3. A method according to claim 1, wherein said applying the redo record includes:
determining whether the change number of the redo record is greater than the baseline change number; and
executing the redo record on the target table of the logical standby database system if the change number exceeds the baseline change number.

4. A method according to claim 3, wherein the change number in the message is captured while the primary database system is operational.

5. A method according to claim 1, wherein said establishing includes recording the extracted change number during an insert-select operation.

6. A computer-readable medium bearing instructions for supporting a logical standby database, said instructions being arranged, upon execution, to cause one or more processors to perform the step of a method according to claim 1.

7. A method for providing a logical standby database system for a primary database system, comprising:
issuing a lock request against a source table on the primary database system followed by an unlock request against the source table;
capturing a change number generated on the primary database system while the primary database system is operational;
incorporating the change number in a message that is transmitted between the primary database system and the logical standby database system in accordance with a protocol that synchronizes the change number between the primary database and the logical standby database;
extracting the change number from the message transmitted to the logical standby database system;
recording the change number extracted from the message during an insert-select operation as a baseline change number for a target table on the logical standby database system that corresponds to the source table; and
selectively applying a redo record for the source table transmitted from the primary database system to target table on the logical standby database system based upon the baseline change number and a change number of the redo record by:
determining whether the change number of the redo record is greater than the baseline change number; and
executing the redo record on the target table of the logical standby database system if the change number exceeds the baseline change number.

8. A distributed database system, comprising:
a primary database system storing a source table and configured for:
capturing a change number generated on the primary database system while the primary database system is operational; and
incorporating the change number in a message that is transmitted between the primary database system and the logical standby database system in accordance with a protocol that synchronizes the change number between the primary database and the logical standby database; and
a logical standby database system in communication with the primary database system and configured for:
extracting the change number from the message transmitted to the logical standby database system;
establishing the change number extracted from the message as a baseline change number for a target table on the logical standby database system that corresponds to the source table; and
selectively applying a redo record for the source table transmitted from the primary database system to target table on the logical standby database system based upon the baseline change number and a change number of the redo record.

9. A distributed database system according to claim 8, wherein the primary database system is further configured for:
issuing a lock request against a source table on the primary database system followed by an unlock request against the source table.

10. A distributed database system according to claim 8, wherein the logical standby database system is further configured for:
recording the change number extracted from the message during an insert-select operation.

11. A distributed database system according to claim 8, wherein the logical standby database system is further configured for:
determining whether the change number of the redo record is greater than the baseline change number; and
executing the redo record on the target table of the logical standby database system if the change number exceeds the baseline change number.
